(19) United States
(12) Patent Application Publication
(10) Pub. No.: US 2016/0326787 A1
(43) Pub. Date: Nov. 10, 2016

(54) SYSTEM AND METHODS FOR SECURING A HINGE TO A FRAME

(71) Applicant: Amesbury Group, Inc., Amesbury, MA (US)

(72) Inventor: Douglas John Criddle, Sioux Falls, SD (US)

(21) Appl. No.: 14/708,009

(22) Filed: May 8, 2015

(51) Int. Cl. E05D 5/02

(52) U.S. Cl. CPC E05D 5/0215

(57) ABSTRACT

A first plate has a first plate body with a lip integral with and parallel to the first plate body. An opening is defined by the first plate. A second plate is disposed on a first side of the first plate body. The second plate body has at least one edge. A projection extending from the second plate is configured to mate with the first plate opening.

### INTRODUCTION

Systems for mounting hinges to extruded metal or plastic door or window profiles can be difficult to install. For very heavy panels, systems are generally in the form of plates that are slid into a groove in the profile from an end of the profile. In that case, the frame or panel into which the plates are inserted cannot be assembled prior to insertion of the plates. Instead, one or more plates are slid into the groove (of a side portion, e.g.) from an end thereof. Thereafter, an upper portion of the frame or panel would then be attached to the side portion. In such a process, the plate is prone to falling out of the groove during manufacturing. More lightweight panel systems utilize an element that clamps onto an edge of the groove, but these clamps often lack required holding strength if the panel is too heavy or is aggressively pulled.

### SUMMARY

In one aspect, the technology relates to an apparatus having: a first plate having: a first plate body; a lip integral with and substantially parallel to the first plate body; a first plate opening defined by the first plate; and a second plate disposed on a first side of the first plate body, the second plate having: a second plate body having at least one edge; and a projection extending from the second plate, wherein the projection is configured to mate with the first plate opening. In an embodiment, the opening includes a plurality of recesses and the projection includes a plurality of projections. In another embodiment, the first plate body at least partially defines the first plate opening, and wherein the second plate at least partially defines a second plate opening substantially coaxial with the first plate opening. In yet another embodiment, the second plate further includes a collar substantially coaxial with the second plate opening, and wherein the collar is received in the first plate opening. In still another embodiment, a wall connects the lip to the first plate body.

In another embodiment of the above aspect, the wall is disposed substantially non-orthogonal to both the first plate body and the lip. In an embodiment, the projection extends from the at least one edge and wherein the first plate opening is defined by the wall. In yet another embodiment, the second plate is substantially aligned with the lip when the projection mates with the first plate opening.

In another aspect, the technology relates to a method of installing a hinge clamp system into a groove of a frame having a side portion and an upper portion connected to the side, wherein the groove has a substantially C-shaped cross section having a closed rear portion, an open front portion, a first recessed side portion, and a second recessed side portion, the method including: inserting a first edge of a rear plate at least partially into the first recessed side portion; inserting a second edge of a front plate at least partially into the second recessed side portion; substantially simultaneously pivoting the rear plate and the front plate; engaging a projection on the rear plate with an opening at least partially defined by the front plate; and securing a hinge to the rear plate. In an embodiment, the engaging operation includes positioning a tooth projecting from the rear plate into the opening, wherein the opening is at least partially defined by a front plate wall. In another embodiment, the pivoting operation includes pivoting the rear plate and the front plate in opposite directions. In yet another embodiment, the pivoting operation and the engaging operation are performed substantially simultaneously. In still another embodiment, the engaging operation includes positioning a collar projecting from the rear plate into the opening wherein the opening is at least partially defined by a front plate body. In another embodiment, the securing operation includes passing a screw through the rear plate so as to contact the closed rear portion of the groove.

In another aspect, the technology relates to an apparatus having: a first plate having: a first plate body; and a projection extending from the first plate body; and a second plate at least partially defining an opening for receiving the projection of the first plate. In an embodiment, the projection includes a collar and wherein the opening is at least partially defined by a second plate body. In another embodiment, the first plate further includes an edge and the second plate includes a body, a lip, and a wall connecting the body and the lip, and wherein the projection includes a tooth projecting from the edge and the opening is at least partially defined by the wall. In yet another embodiment, the opening includes a plurality of openings and the projection includes a plurality of projections. In still another embodiment, the first plate body and the second plate are substantially parallel when the projection is received in the opening. In another embodiment, the first plate defines a through-opening substantially coaxial with the collar.

### BRIEF DESCRIPTION OF THE DRAWINGS

There are shown in the drawings, examples which are presently preferred, it being understood, however, that the technology is not limited to the precise arrangements and instrumentalities shown.

FIG. 1 is a perspective view of a frame and a pivoting panel connected by a hinge.

FIG. 2 is an exploded perspective view of a hinge mounting system and hinge.

FIGS. 3A and 3B are front and rear exploded perspective views, respectively, of a hinge mounting system.

FIGS. 4A and 4B are front and rear exploded perspective views, respectively, of another example of a hinge mounting system.

FIGS. 5A-5C depict a method of installing a hinge utilizing a hinge mounting system.

### DETAILED DESCRIPTION

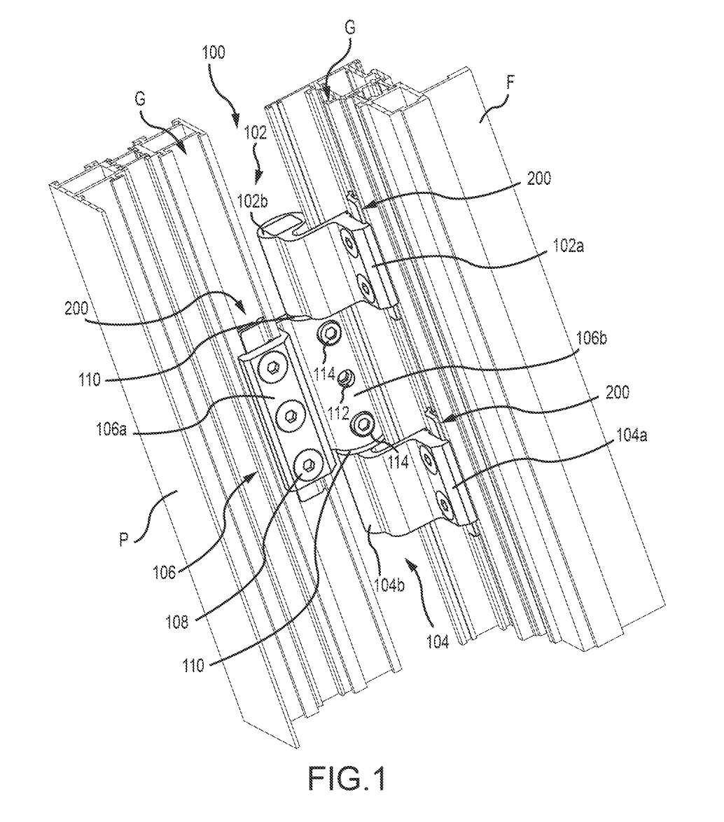

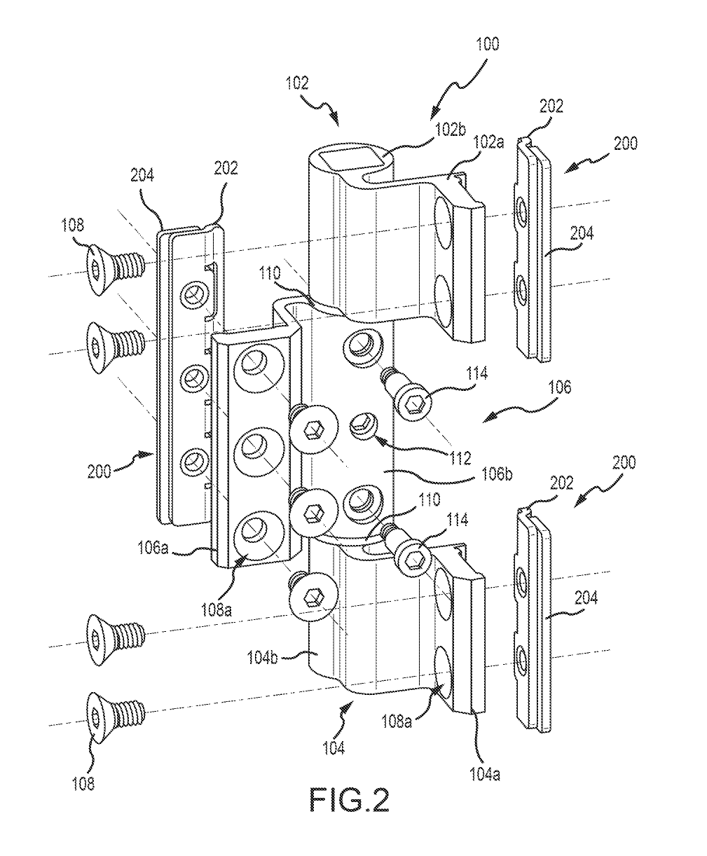

FIG. 1 is a perspective view of a frame F and a pivoting panel P connected by a hinge 100. FIG. 2 is an exploded perspective view of a hinge mounting system 200 and the hinge 100 and is described simultaneously with FIG. 1. The frame F can be a door frame or a window frame. For the purposes of clarity, further reference to the frame F will be to a door frame. The pivoting panel P can be a door panel or pivoting window sash. For the purposes of clarity, further reference to the pivoting panel P will be to a door panel. The hinge 100 is used to adjust a position of the door panel P relative to the door frame F. The hinge 100 includes an upper outer section or knuckle 102, a lower outer section or knuckle 104, and a middle or central section or knuckle 106. Each section or knuckle 102-106 includes a leaf 102a, 104a, 106a and a barrel 102b, 104b, 106b secured thereto. Each leaf 102a, 104a, 106a defines one or more openings 108a that receive screws, bolts, or other fasteners 108 to secure the leaf 102a, 104a, 106a to a door panel or a door frame. In certain examples, upper and lower outer leaves 102a, 104a are secured to the door frame F, while the middle leaf 106a is secured to the door panel P. Each of the upper and lower outer barrels 102b, 104b may be spaced from the middle barrel 106b with a low-friction bushing 110. In the depicted example, the hinge 100 is adjustable such that the middle barrel 106b defines an access or adjustment opening 112 configured to allow tool access to enable adjustment of an adjustment mechanism, described below. Additionally, one or more slides 114 may be secured within the middle barrel 106b to reduce binding during adjustment of the adjustment mechanism, as described below. A hinge mounting system 200 is used to secure each leaf 102a, 104a, 106a into a groove G of a respective frame F or panel P. This hinge mounting system 200 may also be used with non-adjustable hinges. Each hinge mounting system 200 includes two plates 202, 204 and is described in more detail below.

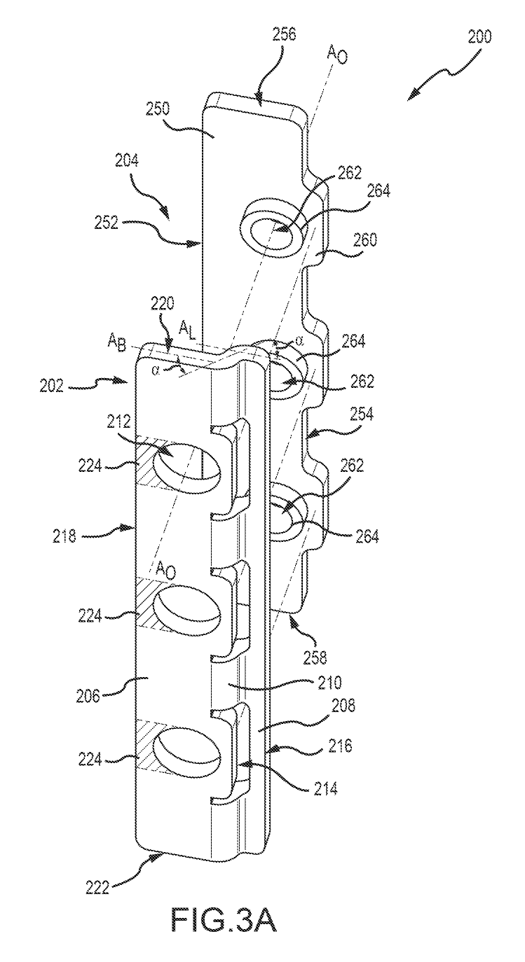

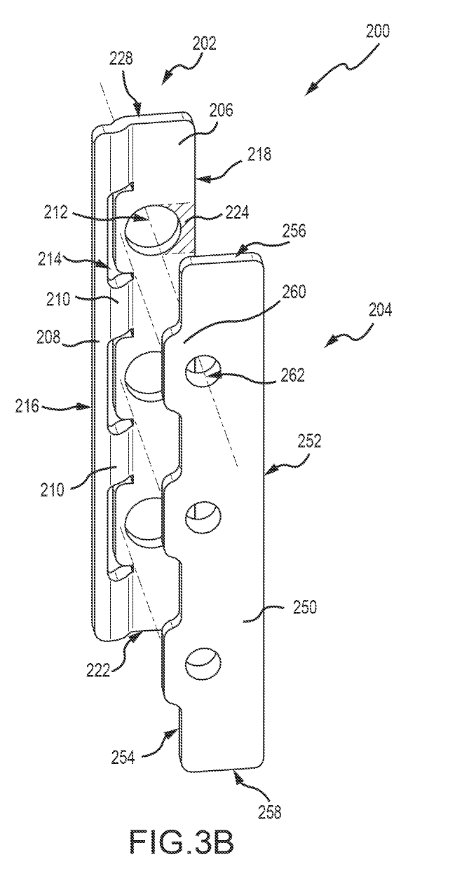

FIGS. 3A and 3B are front and rear exploded perspective views, respectively, of the hinge mounting system 200 and are described simultaneously. The system 200 includes a first or front plate 202 and a second or rear plate 204. The front plate 202 is installed forward of the rear plate 204 when the hinge mounting system 200 is installed in a groove of a frame or panel. Installation of the system 200 is described in more detail below. The front plate 202 includes a substantially planar plate body 206. The front plate body 206 defines a front plate body axis A_{B}. A lip 208 is connected to the front plate body 206 at a wall 210 and includes a lip axis A_{L} that is substantially parallel to the front plate body axis A_{B}. The plate body 206, the wall 210, and the lip 208 may be an integral, unitary component. The front plate body 206 may define one or more openings 212, the purpose of which is described in more detail below. The wall 210, in the depicted example, is disposed at a non-orthogonal angle a to both the plate body 206 and the lip 208. In other examples, the wall 210 may be disposed at an orthogonal angle to either or both of the plate body 206 and the lip 208. In the depicted example, the front plate 202 defines one or more openings 214 therein. More specifically, the openings 214 may be defined by the wall 210, lip 208, and/or the body 206. In certain examples, the openings 212 may extend into shaded areas 224, so as to form substantially U-shaped openings partially defined by the plate body 206. Such U-shaped opening may provide more clearance for collars 264 during installation, as described below. The front plate 202 also includes a number of edges, for example, a first edge 216, disposed generally at the lip 208, and a second edge 218 disposed generally at the plate body 206. The front plate 202 also includes a top edge 220 and a bottom edge 222.

The rear plate 204 includes a rear plate body 250. The rear plate 204 also includes a number of edges, for example, a first edge 252 and a second edge 254. The rear plate 204 also includes a top edge 256 and a bottom edge 258. One or more projections or teeth 260 project from the second edge 254. The rear plate 204 also defines a bore 262 that may be threaded so as to receive a screw or bolt, as described below. In this example, the rear plate 204 also includes a raised collar 264, which may be threaded or unthreaded, and that is axially aligned with an opening axis A_{O}. Once installed, the openings 212 are also coaxial with the opening axis A_{O}.

The front plate 202 is configured to mate with the rear plate 204 when these components are inserted into a groove of a frame or panel. In general, one or more projections on one of the plates 202, 204 may mate with one or more recesses or openings on the other of the plates 202, 204. In one example, the projections may be the raised collars 264 that mate with the openings 212 in the front plate body 206. In another example, the projections may be the teeth 260 that mate with the openings 214 in the wall 210. In certain examples, both mating structures are present. In the example of FIGS. 3A and 3B, three collars 264 mate with the three openings 212. Additionally, three teeth 260 mate with three openings 214. Other examples may utilize greater or fewer than three mating arrangements.

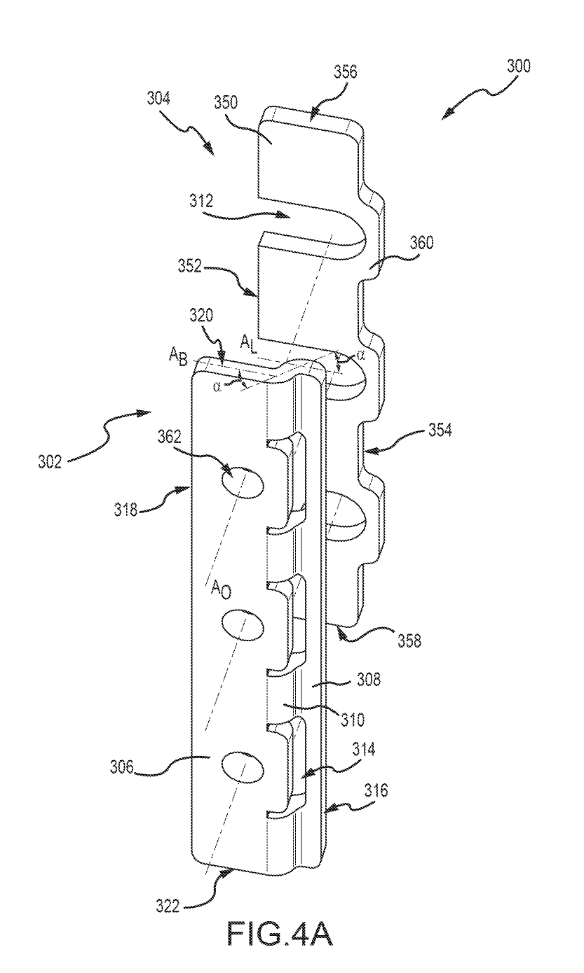

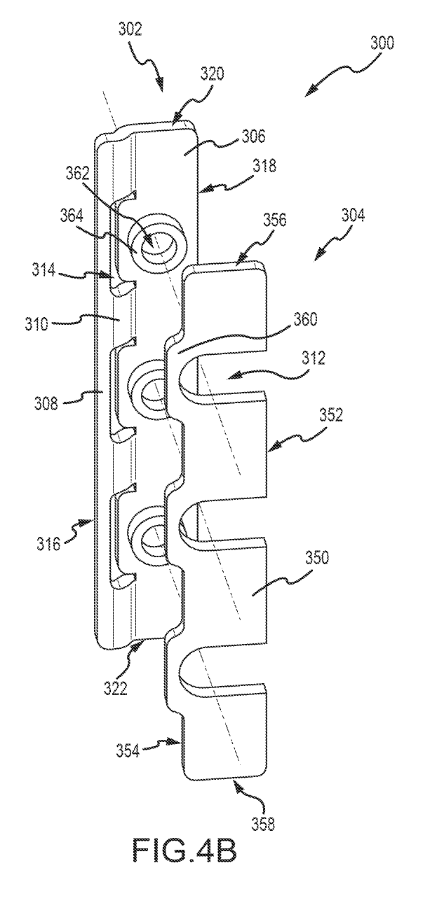

FIGS. 4A and 4B are front and rear exploded perspective views, respectively, of another example of a hinge mounting system 300 and are described simultaneously. The system 300 includes a first or front plate 302 and a second or rear plate 304. The front plate 302 is installed forward of the rear plate 304 when the hinge mounting system 300 is installed in a groove of a frame or panel. The front plate 302 includes a substantially planar plate body 306. The front plate body 306 defines a front plate body axis A_{B}. A lip 308 is connected to the front plate body 306 at a wall 310 and includes a lip axis A_{L} that is substantially parallel to the front plate body axis A_{B}. The plate body 306, the wall 310, and the lip 308 may be an integral, unitary component. The wall 310, in the depicted example, is disposed at a non-orthogonal angle a to both the plate body 306 and the lip 308. In other examples, the wall 310 may be disposed at an orthogonal angle to either or both of the plate body 306 and the lip 308. In the depicted example, the front plate 302 defines one or more openings 314 therein. More specifically, the openings 314 may be defined by the wall 310, lip 308, and/or the body 306. The front plate 302 also includes a number of edges, for example, a first edge 316, disposed generally at the lip 308, and a second edge 318 disposed generally at the plate body 306. The front plate 302 also includes a top edge 320 and a bottom edge 322. The rear plate 304 includes a rear plate body 350. The rear plate 304 also includes a number of edges, for example, a first edge 352 and a second edge 354. The rear plate 304 also includes a top edge 356 and a bottom edge 358. One or more projections or teeth 360 project from the second edge 354.

The front plate 302 is configured to mate with the rear plate 304 when these components are inserted into a groove of a frame or panel. In general, one or more projections on one of the plates 302, 304 may mate with one or more recesses or openings on the other of the plates 302, 304. However, the location of certain of the projections and openings is different than the example of FIGS. 3A and 3B. More specifically, the rear plate body 356 defines one or more openings 312 that are substantially U-shaped openings 312 partially defined by the plate body 350. Such U-shaped openings 312 may provide more clearance for collars 364 during installation. The front plate 302 also defines a bore 362 that may be threaded so as to receive a screw or bolt, as described below. In this example, the front plate 302 also includes a raised collar 364, which may be threaded or unthreaded, and that is axially aligned with an opening axis A_{O}. Once installed, the openings 312 are also coaxial with the opening axis A_{O}. The mating relationships between these elements perform substantially similar functions to the elements described above with regard to FIGS. 3A and 3B.

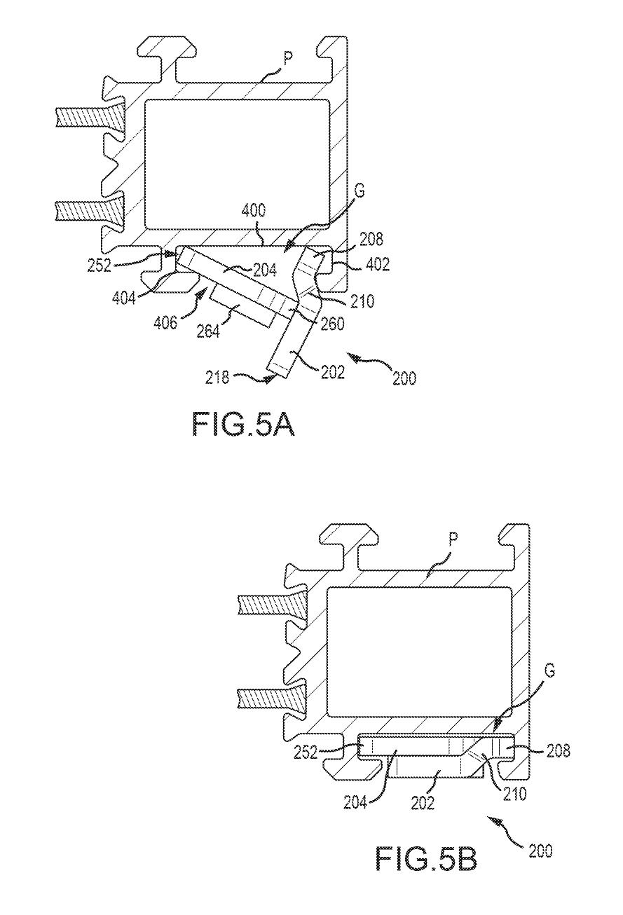

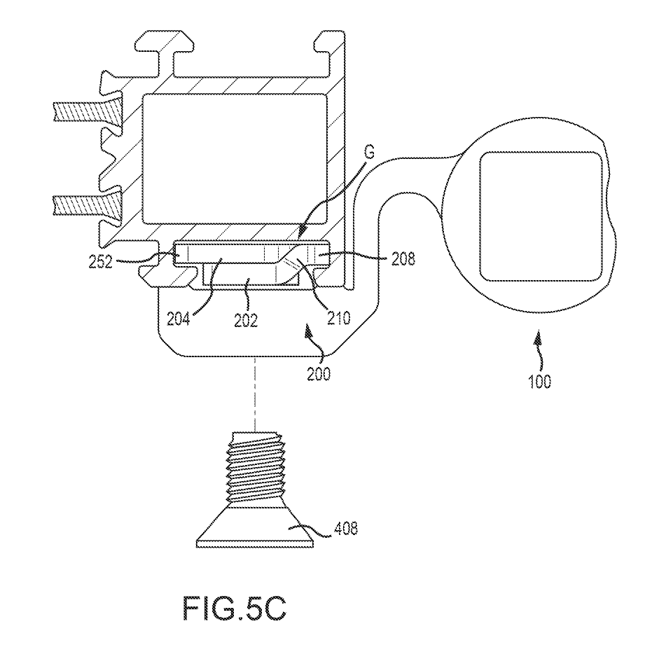

FIGS. 5A-5C depict a method of installing a hinge 100 utilizing a hinge mounting system 200. The hinge mounting system 200 may be installed in a groove G of a panel P or frame. The groove G has a substantially C-shaped cross section with a closed rear portion 400. Extending from either end of the closed rear portion 400 are two recessed side portions 402, 404. The recessed side portions 402, 404 together define an open front portion 406 into which the hinge mounting system 200 is received. Unlike prior systems, where plates must be slid into the groove from an end thereof, the clamp systems depicted herein are inserted via the open front portion 406 of the groove G. With the hinge mounting systems 200 depicted herein, the systems 200 may be installed after complete manufacture of a frame or panel. In that case, the depicted systems 200 are also advantageous for retrofitting or replacement into existing construction.

The method begins with inserting an edge 252 of a rear plate 204 into the first recessed side portion 404. Similarly, an edge (in this case, the lip 208) of the front plate 202 is inserted into the second recessed side portion 402, opposite the first side portion 404. As depicted in FIG. 5A, insertion of both plates 202, 204 is at an angle to their respective recessed side portions 402, 404. The front plate 202 and rear plate 204 are then pivoted towards the closed rear portion 400 of the groove G. Since opposite edges of the plates 202, 204 are inserted into opposite recessed side portions 404, 402, the plates 202, 204 are pivoted in opposite directions of rotation. As the plates 202, 204 are rotated, one or more projections on the rear plate 204 engage one or more openings on the front plate 202. This condition is depicted in FIG. 5B. For example, the raised collars 264 can mate with the openings 212 in the front plate body 206. Alternatively or additionally, the teeth 260 can mate with the openings 214 in the wall 210. When the projections mate with their respective openings, the plate 204 is substantially aligned with the lip 208. Once positioned, the hinge 100 can be secured to the mounting system 200, with e.g., a screw or bolt 408 passing through the opening 212 and the collar 264. In certain examples, as the screw or bolt 408 penetrates the front plate 202 and the rear plate 204, it presses against the closed rear portion 400, biasing the front plate 202 and the rear plate 204 away from the closed rear portion 400, so as to hold the mounting system 200 tight within the recessed side portions 402, 404. This holds the hinge 100 in place and prevents sliding thereof.

The materials utilized in the manufacture of the hinge mounting systems described herein may be those typically utilized for hinge manufacture, e.g., zinc, steel, aluminum, brass, stainless steel, etc. Material selection for most of the components may be based on the proposed use of the mounting system. Appropriate materials may be selected for mounting systems used on particularly heavy panels, as well as on hinges subject to certain environmental conditions (e.g., moisture, corrosive atmospheres, etc.). For particularly light-weight panels (for example, cabinet door panels), molded plastic, such as PVC, polyethylene, etc., may be utilized for the various components.

The terms first, second, front, rear, middle, top, bottom, panel, frame, etc., as used herein, are relative terms used for convenience of the reader and to differentiate various elements of the hinge mounting system from each other. In general, unless otherwise noted, the terms are not meant to define or otherwise restrict location of any particular element. For example, the hinge mounting system may be used with the hinge/panel arrangements that are oriented horizontally.

While there have been described herein what are to be considered exemplary and preferred examples of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. An apparatus comprising:
a first plate comprising:
a first plate body;
a lip integral with and substantially parallel to the first plate body;
a first plate opening defined by the first plate; and
a second plate disposed on a first side of the first plate body, the second plate comprising:
a second plate body comprising at least one edge; and
a projection extending from the second plate, wherein the projection is configured to mate with the first plate opening.

2. The apparatus of claim 1, wherein the opening comprises a plurality of recesses and the projection comprises a plurality of projections.

3. The apparatus of claim 1, wherein the first plate body at least partially defines the first plate opening, and wherein the second plate at least partially defines a second plate opening substantially coaxial with the first plate opening.

4. The apparatus of claim 3, wherein the second plate further comprises a collar substantially coaxial with the second plate opening, and wherein the collar is received in the first plate opening.

5. The apparatus of claim 1, further comprising a wall connecting the lip to the first plate body.

6. The apparatus of claim 5, wherein the wall is disposed substantially non-orthogonal to both the first plate body and the lip.

7. The apparatus of claim 5, wherein the projection extends from the at least one edge and wherein the first plate opening is defined by the wall.

8. The apparatus of claim 1, wherein the second plate is substantially aligned with the lip when the projection mates with the first plate opening.

9. A method of installing a hinge clamp system into a groove of a frame comprising an side portion and an upper portion connected to the side, wherein the groove comprises a substantially C-shaped cross section having a closed rear portion, an open front portion, a first recessed side portion, and a second recessed side portion, the method comprising:
inserting a first edge of a rear plate at least partially into the first recessed side portion;
inserting a second edge of a front plate at least partially into the second recessed side portion;
substantially simultaneously pivoting the rear plate and the front plate;
engaging a projection on the rear plate with an opening at least partially defined by the front plate; and
securing a hinge to the rear plate.

10. The method of claim 9, wherein the engaging operation comprises positioning a tooth projecting from the rear plate into the opening, wherein the opening is at least partially defined by a front plate wall.

11. The method of claim 9, wherein the pivoting operation comprises pivoting the rear plate and the front plate in opposite directions.

12. The method of claim 9, wherein the pivoting operation and the engaging operation are performed substantially simultaneously.

13. The method of claim 9, wherein the engaging operation comprises positioning a collar projecting from the rear plate into the opening wherein the opening is at least partially defined by a front plate body.

14. The method of claim 9, wherein the securing operation comprises passing a screw through the rear plate so as to contact the closed rear portion of the groove.

15. An apparatus comprising:
a first plate comprising:
a first plate body; and
a projection extending from the first plate body; and
a second plate at least partially defining an opening for receiving the projection of the first plate.

16. The apparatus of claim 15, wherein the projection comprises a collar and wherein the opening is at least partially defined by a second plate body.

17. The apparatus of claim 15, wherein the first plate further comprises an edge and the second plate comprises a body, a lip, and a wall connecting the body and the lip, and wherein the projection comprises a tooth projecting from the edge and the opening is at least partially defined by the wall.

18. The apparatus of claim 15, wherein the opening comprises a plurality of openings and the projection comprises a plurality of projections.

19. The apparatus of claim 15, wherein the first plate body and the second plate are substantially parallel when the projection is received in the opening.

20. The apparatus of claim 16, wherein the first plate defines a through-opening substantially coaxial with the collar.
